(19) United States
(12) Patent Application Publication
(10) Pub. No.: US 2021/0388973 A1
(43) Pub. Date: Dec. 16, 2021

(54) BRACKETS OF EMBEDDED LAMP

(71) Applicant: CHO ROK LIGHT CO.,LTD, Chuncheon-si, Gangwon-do (KR)

(72) Inventor: Hae Gon LEE, Chuncheon-si (KR)

(73) Assignee: CHO ROK LIGHT CO.,LTD, Chuncheon-si, Gangwon-do (KR)

(21) Appl. No.: 17/295,018

(22) PCT Filed: Nov. 18, 2019
(86) PCT No.: PCT/KR2019/015765

§ 371 Date: May 18, 2021

(30) Foreign Application Priority Data
Nov. 20, 2018 (KR) 10-2018-0143335

(51) Int. Cl. F21V 21/04; F21S 8/02

(52) U.S. Cl. CPC F21V 21/044; F21V 21/048; F21S 8/026

(57) ABSTRACT

The present invention relates to brackets for fixing a lamp to be embedded in the ceiling of a building to an M bar inside the ceiling and, more specifically, to brackets having a plurality of hook bars (100) hung on an M bar of the ceiling such that the brackets are loosely hung on the M bar in one step and then, a lamp is brought into close contact with the ceiling by only pressing control buttons (300) without tightening a screw. Brackets for an embedded lamp, according to the present invention, comprises a plurality of brackets on the edge of the lamp. A body of each bracket comprises a spring fixing shaft (100-4), two vertical movement guides, and one horizontal movement guide. In particular, a hook bar and a control button (300) are seated on a guide which forms a vertical movement path, and a control bar (200) and a control bar spring (200-2) are seated on a horizontal guide which forms a horizontal movement path. Thereafter, when the hook bar (100) pushed downward by a hook spring (100-3) is pulled upward, the control bar (200) is pushed to the left by means of the elasticity of the control bar spring (200-2) and thus blocks the back of the hook bar (100) such that a gap between a hook head. (100-1) and the bracket body is fixed in a widened state. When the hook head (100-1) is hung on the M bar in this state, the lamp is loosely mounted on the M bar. When pushing the edge of the lamp upward, the control button (300) is pressed against the N bar and pushes the control bar (200) to the right, and thereafter, as the hook head (100-1) is pulled by means of the elasticity of the hook spring (100-3), the lamp is brought into close contact with the ceiling.

### TECHNICAL FIELD

The present disclosure relates to a bracket for fixing a lamp embedded in the ceiling of a building to an M bar inside the ceiling, and more particularly, to a bracket that allows an embedded lamp to make close contact with the ceiling with only a control button 300 without tightening a screw when a plurality of hook bars 100 provided to an edge of the lamp so as to be hung on the M bar is loosely hung on the M bar.

### BACKGROUND ART

In general, lamps installed on the ceiling of a building can be classified into embedded lamps and exposed lamps. In the case of the embedded lamp, after removing tiles from the ceiling of the building according to the size of the lamp, the base of the lamp is put into the ceiling, and the lamp is exposed to the outside with only the rim of the lamp making close contact with the ceiling. In comparison, the exposed lamp is installed in a factory with a high ceiling such that even the base of the lamp is exposed. When installing a conventional embedded lamp in the ceiling, wiring is performed with the lamp held in one hand. Then, the base of the lamp is embedded in the ceiling and the rim of the lamp is arranged to overlap the M bar on the ceiling. Then, the lamp is mounted by inserting a screw into the rim. However, this method takes a lot of time to mount the lamp and thus increases the labor cost. Further, because the screws are exposed to the outside, a separate cover must be placed to improve aesthetics, which raises a cost issue. In order to address such issues, a bracket allowing the lamp to be mounted by seating the base of the lamp on the M bar on the ceiling has been devised. However, with such a bracket, the cost reduction effect may not be achieved due to the large number of auxiliary parts that allow the bracket to be resilient and detachable. In addition, since the bracket is simply placed on the M bar of the ceiling, the main body of the lamp may be moved and separated from the M bar on the ceiling by external shock or the like, thus falling, and thereby causing an accident.

### DISCLOSURE

### Technical Problem

Therefore, the present disclosure has been made in view of the above problems, and it is one object of the present disclosure to provide a bracket that firmly surrounds an M bar using a U-shaped hook head without screwing to improve aesthetics and allows a lamp to be firmly mounted.

The objects to be achieved in the present disclosure are not limited to those mentioned above. Additional objects and features of the disclosure will be set forth in part in the description which follows and in part will become apparent to those having ordinary skill in the art upon examination of the following.

### Technical Solution

According to the present disclosure, a plurality of brackets for an embedded lamp is provided on a rim of the lamp. The bracket includes a hook part configured to hang the lamp on an M bar and including a hook bar and a hook bar guide, a control part configured to control vertical movement of the hook bar and including a control bar and a control bar guide, and a button part configured to push the control bar to a right side and including a control button and a button guide.

When the hook bar 100, which is subjected to force applied downward by a hook spring 100-3, is pulled upward, the control bar 200 is pushed to the left by the elasticity of the control bar spring 200-2 to block the back of the hook bar 100. Thus, the hook bar is fixed with the hook head 100-1 and the bracket body being spaced apart from each other. When the hook head 100-1 is hooked on the M bar in this state, the lamp is loosely mounted on the M bar. Thereafter, when the lamp is pushed upward again, the control button 300 is pressed by the M bar, and the control bar 200 is then retracted.

As a result, the hook head 100-1 is pulled by the elasticity of the hook spring 100-3, and the lamp is brought into close contact with the ceiling.

### Advantageous Effects

According to brackets for an embedded lamp of the present disclosure described above, the screw tightening operation is not required, and thus there is no need for a separate tool. In addition, the labor cost for installation may be reduced. Further, there is no external screw mark created, and therefore there is no need to fabricate a separate cover to conceal the same. In addition, as a U-shaped hook head is employed, the lamp may be prevented from falling and causing an accident when it undergoes external impact.

### DESCRIPTION OF DRAWINGS

FIG. 1 is a perspective view of a bracket for an embedded lamp that is integrally attached to the lamp according to the present disclosure.

FIG. 2 is a perspective view of the internal structure of the bracket for an embedded lamp according to the present disclosure.

FIG. 3 is a perspective view illustrating the interlocking relationship between the control button 300 and the control bar 200 in the bracket for an embedded lamp according to the present disclosure.

### BEST MODE

The present disclosure relates to a bracket for a lamp embedded in the ceiling of a building, and more particularly, to a bracket capable of bringing the lamp into close contact with the ceiling with only a control button without tightening screws after being loosely hung on an M bar.

Terms related to lamps used to describe the configuration of the bracket of the present disclosure for achieving the above objects, that is, wires, M-bar, base, rim, diffusion plate, bracket, and the like, are defined as follows.

The term “wire” refers to a cable and includes not only the function of transmitting electric energy, but also the function of transmitting various radio signals and optical signals from a central control device for the Internet of Things.

Inside the ceiling where the lamp is installed, a ceiling plate material such as textile covering the ceiling is fixed to an aggregate such as a ceiling bar with screws. For such a ceiling bar, an M bar or a T bar is generally employed. In the present disclosure, general ceiling bars will be collectively referred to as M bars.

Terms such as base, rim, and diffusion plate, which are used to describe the structure of the lamp, are defined as follows.

An embedded lamp is generally divided into a light source and a housing, which is a structure surrounding the light source. The housing functions to fix the light source therein, block foreign substances such as insects or dust from entering, and convert direct light from the light source into indirect light. Most of these housings have a low-height rectangular parallelepiped or cylindrical shape. In the present disclosure, a part that is arranged at the top of the housing to fix the light source and function as a cover is called a “base.” A part that defines the edge of the lamp by extending perpendicularly or obliquely from the base is called a “rim.” A part that is disposed on the bottom surface of the housing to convert the light from the light source into indirect light while and filter the light evenly and smoothly is called a “diffusion plate.” Also, a separate structure provided to install the lamp on the M bar on the ceiling is called a “bracket.”

In the following description, it should be noted that only parts necessary to understand the configuration of the present disclosure will be disclosed, and descriptions of other parts will be omitted so as not to obscure the subject matter of the present disclosure.

In addition, it should be noted that terms or words used in the present specification and claims have been arbitrarily defined by the inventor in describing the invention.

Hereinafter, based on the above definition of the terms used in the description of the present disclosure, the structure of the bracket for an embedded lamp according to the present disclosure will be described.

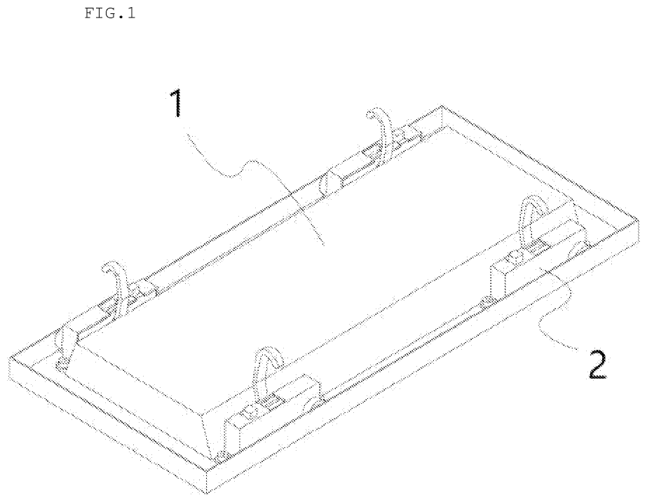

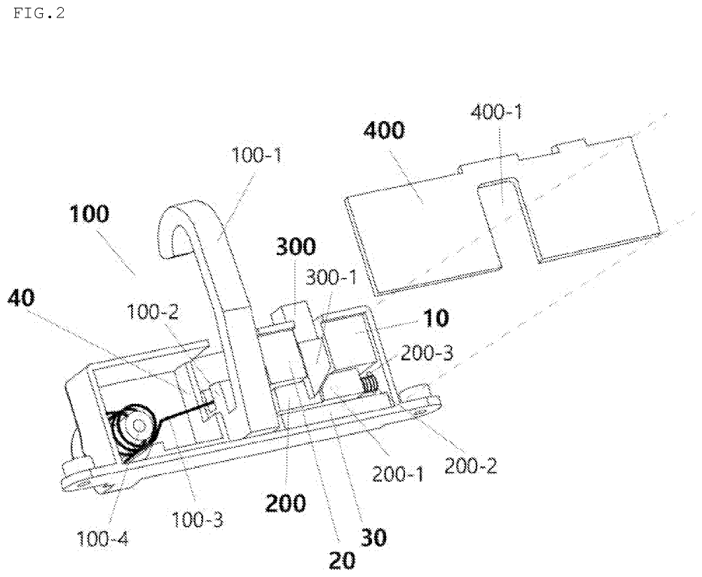

FIG. 1 is a perspective view of a bracket for an embedded lamp that is integrally attached to the lamp according to the present disclosure, and FIG. 2 is an exploded perspective view of the bracket according to the present disclosure.

As shown in FIG. 2, the bracket for an embedded lamp according to the present disclosure includes a hook part configured to hang the lamp on an M bar and including a hook bar and a hook bar guide, a control part configured to control reciprocation of the hook bar and including a control bar and a control bar guide, and a button part configured to push the control bar to a right side and including a control button and a button guide.

First, the structure of the hook part will be described in detail.

A block 40 and a block 20 define a hook bar guide, which is a passage for vertical travel of the hook bar. The hook bar 100 is seated in the hook bar guide. A “-” shaped hook groove 100-2 is provided at a lower end of the hook bar 100, and a U-shaped streamlined hook head 100-1 is provided at an upper end of the hook bar 100, which protrudes outward through a cut-open part 400-1 of a bracket body front surface 400.

The hook bar 100 is preferably formed of a plastic material so as to have elasticity because it must be bent in and out when embedded in the ceiling.

In addition, a spring fixing shaft 100-4 is provided on one side of the hook part, and the hook spring 100-3 is seated thereon. One end of the hook spring 100-3 is inserted into the hook groove 100-2 at the lower end of the hook bar 100 through the cut-open part of the partition block 40. Thereby, force is constantly applied downward to the hook bar 100 by the elasticity of the spring.

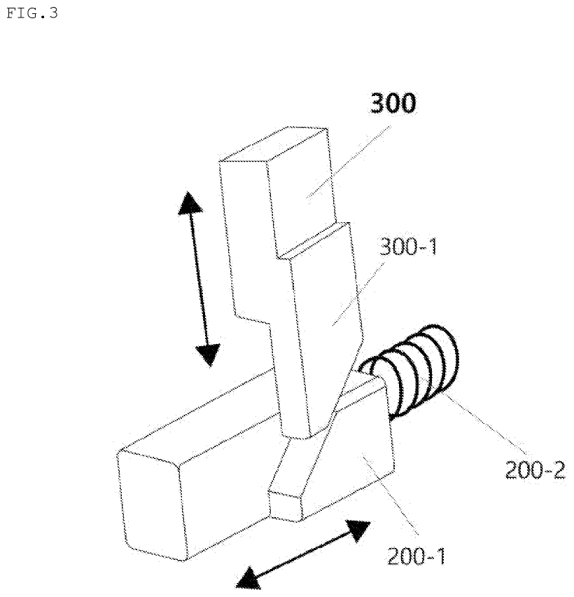

The block 20 and the block 30 create a control bar guide, which is a passage for lateral movement of the control bar 200, and the control bar 200 is seated in the control bar guide. The control bar 200 is constantly subjected to leftward pushing force by the control bar spring 200-2 seated in the spring groove 200-3. In addition, an intermediate inclined surface 200-1 integrated with the control bar 200 is formed in the middle of the control bar 200 in a protruding shape. The intermediate inclined surface 200-1 is matched with a button inclined surface 300-1 at the lower end of the control button 300 as shown in FIG. 3, and is thus operatively connected to movement of the control button 300.

Next, the block 10 and the block 20 define a button guide, which is a passage through which the control button 300 can move up and down, and the control button 300 is seated in the button guide. A button inclined surface 300-1 is formed at the lower end of the control button 300 so as to be integrated with the control button 300, and is matched with the intermediate inclined surface 200-1 of the control bar 200 so as to be operatively connected to the control bar 200, as shown in FIG. 3.

A preferred embodiment of use of the bracket 2 for an embedded lamp configured as above according to the present disclosure is described below.

When a plurality of brackets 2 for an embedded lamp according to the present disclosure is integrally seated on the rim or base of the lamp 1, and is used to mount the lamp on an M bar on the ceiling, the gap between the hook head 100-1 and the bracket bodies should be widened by pulling the hook heads 100-1 of all the brackets 2. More specifically, when the hook head 100-1 is pulled, the hook bar 100 is raised. Then the control bar 200 is pushed to the left by the elasticity of the control bar spring 200-2, causing the control button 300 to rise and protrude. At the same time, the hook bar 100 is blocked from returning downward. As a result, the gap between the hook head 100-1 and the bracket body is kept widened. In this state, when all the hook heads 100-1 on one side of the lamp are hooked to the M bar, the lamp is inclined while being hung on the M bar. Then, the wire on the ceiling is connected to the wire of the lamp. Then, when the remaining hook heads 100-2 are pushed into the M bar, the lamp is mounted loosely while being hung on the M bars on both sides, and the control button 300 is naturally positioned between the lower end of the M bar and the rim of the lamp in a protruding state. Thereafter, when the rim of the lamp is pushed toward the ceiling, the control button 300 is brought into contact with the M bar and pressed, and the control bar 200 operatively connected thereto is pushed to the right. In turn, the hook bar 100 is pushed down by the elasticity of the hook spring 100-3, and as a result, the M bar is strongly tightened such that the lamp can be firmly mounted on the ceiling.

The embedded lamp of the present disclosure is detached from the ceiling in the following procedure.

First, when the frame of the lamp is pulled downward, the hook heads 100-1 of all the brackets 2 are pulled and the hook bars 100 are raised. Subsequently, the control bar 200 is pushed to the left by the elasticity of the control bar spring 200-2, causing the control button 300 to rise and protrude upward. Then, the hook bar 100 is blocked from returning downward. As a result, the lamp is fixed with the gap between the lamp and the ceiling widened. In this state, when the hook heads 100-1 on one side are released with a thin rod inserted into the gap, the lamp is inclined and hung on the M bar. Then, when the lamp is lifted and the remaining hook heads 100-1 are released, the lamp is completely detached.

1. A bracket (2) for an embedded lamp mounted on a ceiling by hanging the lamp on an M bar, the bracket comprising:
a hook part configured to hang the lamp on the M bar, the hook part comprising a hook bar (100) and a hook bar guide;
a control part configured to control vertical movement of the hook bar (100), the control part comprising a control bar (200) and a control bar guide; and
a button part configured to push the control bar to a right side, the button part comprising a control button (300) and a button guide.

2. The bracket of claim 1, wherein the hook bar guide of the hook part is formed by a partition block (20) and a partition block (40),
wherein the hook bar (100) is provided with a U-shaped hook head (100-1) at an upper end thereof, and a hook groove (100-2) at a lower end thereof, and
wherein the hook bar (100) is coupled with one end of a hook spring (100-3) seated on a spring fixing shaft (100-4) on one side.

3. The bracket of claim 1, wherein the control bar guide of the control part is formed by a partition block (20) and a partition block (30),
wherein the control bar (200) is provided with an intermediate inclined surface (200-1) integrally formed on a side surface thereof and operatively connected to a button inclined surface (300-1), and
wherein the control bar (200) is subjected to elastic force of a control bar spring (200-2).

4. The bracket of claim 1, wherein the button guide of the button part is a passage formed by a partition block (10) and a partition block (20),
wherein the control button (300) is provided with a button inclined surface (300-1) integrally formed at a lower end thereof and operatively connected to an intermediate inclined surface (200-1).
